(19) United States
(12) Patent Application Publication
(10) Pub. No.: US 2023/0215171 A1
(43) Pub. Date: Jul. 6, 2023

(54) METHOD FOR ONLINE TEST CHEATING DETECTION USING DEEP NEURAL NETWORK AND HABIT CAPTURE

(71) Applicant: Daniel Kim, Chappaqua, NY (US)

(72) Inventor: Daniel Kim, Chappaqua, NY (US)

(21) Appl. No.: 18/181,445

(22) Filed: Mar. 9, 2023

(51) Int. Cl. G06V 20/40; G06V 10/774; G06V 10/82; G06V 40/20

(52) U.S. Cl. CPC G06V 20/41; G06V 10/774; G06V 10/82; G06V 40/20

(57) ABSTRACT

Embodiments of the invention are directed to a method for providing online test cheating detection. A non-limiting example of the method includes acquiring a test taker's normal test behavior, also referred to as habit data, through a pre-test. During the main test, the habit data is fed as one of inputs to the deep neural network (DNN) along with other real time inputs that represents eye gaze direction and movements of other body parts such as the head, shoulder, and upper body. These real-time input data are extracted from the visual data captured by the test taker's camera. The deep neural network (DNN) is pre-trained using a pre-existing database to distinguish abnormal or suspicious behavior from normal test behavior.

### BACKGROUND

The present invention generally relates to a method for the prevention of cheating in online tests and, more specifically, to cheat detection using deep learning and habit capturing.

Online learning, also referred to as remote learning, has been and continues to be widely adopted. The purpose of online learning is to allow learners an alternative to gathering in a certain place. Assessment of learners' progress or achievement is as important to online learning as it is to in-person learning. Assessments for online learning typically take the form of online tests. To ensure an accurate evaluation of learners' achievement and a fair competition among learners, cheating should be prevented to the greatest extent possible.

Proctoring online tests is challenging because proctors have limited visual perception of each learner. Even if all learners have their cameras turned on, proctors can only see a portion of the learner and the environment, which makes it difficult to detect cheating actions such as looking at papers, books, cell phones, additional screens, etc. Proctors cannot continually pay attention to each learner either. Therefore, an automated system to monitor and detect each learner's behavior is necessary.

Some prior arts suggested automated systems that monitor test takers' eye gaze to decide whether a cheating action is occurring by determining if the test taker is looking beyond the computer monitor on which the test is being administered. However, making a judgement based solely on test takers' eye gaze angle or scope can cause many false alarms, making the system unreliable and impractical. Many people have the habit of looking in miscellaneous directions simply to think.

### SUMMARY

Embodiments of the invention are directed to a method for providing online test cheating detection. A non-limiting example of the method includes acquiring a test taker's normal behavior during a test, also referred to as habit data, through a pre-test. During the main test, the habit data is fed as an input to the deep neural network (DNN) along with other real-time inputs that represent eye gaze direction and movements of other body parts such as the head, shoulder, and upper body. These real-time input data are extracted from the visual data captured by the test taker's camera. The deep neural network (DNN) is pre-trained using a pre-existing database to distinguish abnormal or suspicious behavior from normal test behavior.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a flow chart of an online test cheating detection method in accordance with the first embodiments of the invention;

FIG. 2 depicts a functional diagram of an online test cheating detection method in accordance with the first embodiments of the invention;

FIG. 3 depicts a flow chart of an online test cheating detection method in accordance with the second embodiments of the invention;

FIG. 4 depicts a functional diagram of an online test cheating detection method in accordance with the second embodiments of the invention;

FIG. 5 depicts a system diagram of an online test cheating detection method in accordance with one or more embodiments of the invention;

The diagrams depicted herein are illustrative. There can be many variations to the diagram or the operations described therein without departing from the spirit of the invention. For instance, the actions can be performed in a differing order or actions can be added, deleted or modified.

In the accompanying figures and following detailed description of the described embodiments of the invention, the various elements illustrated in the figures are provided with two or three-digit reference numbers. With minor exceptions, the leftmost digit(s) of each reference number correspond to the figure in which its element is first illustrated.

### DETAILED DESCRIPTION

The term “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

It is understood in advance that although exemplary embodiments of the invention are described in connection with deep learning (DL) algorithm or deep neural network (DNN), embodiments of the invention are not limited to the particular algorithm or network described in this specification. Rather, embodiments of the present invention are capable of being implemented in conjunction with any of machine learning (ML) algorithms or in more general any of artificial intelligence (AI) algorithms.

For the sake of brevity, conventional techniques related to deep learning (DL), image recognition and video classification may or may not be described in detail herein. Moreover, the various tasks and process steps described herein can be incorporated into a more comprehensive procedure or process having additional steps or functionality not described in detail herein. In particular, various steps in training deep neural network (DNN) are well known and so, in the interest of brevity, many conventional steps will only be mentioned briefly herein or will be omitted entirely without providing the well-known process details.

Turning now to an overview of aspects of the present invention, one or more embodiments of the invention address the above-described shortcomings by the followings:
1) A pretrained deep neural network (DNN) monitors movement behavior of one or more test taker's body parts.
2) The deep neural network further considers the test taker's habitual behavior data to adapt its decision rule for different test takers.

The DNN takes video input captured by the test taker's camera. The camera may be the same camera that is used for the learner to watch the online learning class. In some embodiments, there may be more than one camera to capture 3-dimensional video data. In some other embodiments, there can be a camera that captures video from the rear side of the test taker.

In some embodiment, the input video data can be pre-processed by one or more pre-processors to extract one or more features so that the abstracted feature data are fed into the DNN. Each pre-processor can be another DNN block or can be a rule-based image processing unit. The pre-processing of the input data may improve the DNN efficiency or reduce the amount of data transmission from each test taker to the central test server.

The DNN is pre-trained using a large training database that includes input data from many persons. Some of the data include cheating behavior and those video frames are labeled accordingly so that the DNN can be trained to activate its output that corresponds to cheating detection for those video frames when cheating is occurring.

In addition to the real time video input captured by the test taker's camera, fixed test taker-dependent video data captured during the pre-test is also used to adjust the DNN's decision characteristic adaptively to each test taker. This allows the DNN to consider or learn variation in behaviors of different test takers.

The fixed test taker-dependent video data is captured during a pre-test step. The pre-test can be scheduled some time prior to the main test. It can be conducted before every main test, or it can be conducted once per each course. The pre-test results will not be used for the learner's assessment of the achievement so that the test taker will not try to cheat, because the behavior during the pre-test will be considered honest test behavior. The pre-test can be repeated until the learner achieves a certain minimum score to make sure that the learner pays enough attention to the pre-test so that the learner's behavior during the pre-test correctly represents honest behavior during real tests.

The difficulty level of the pre-test questions may be set so that all the test takers can achieve the above stated required minimum score. The format of the pre-test will be identical to that of the main test.

In some embodiment, a part of the pre-test may include one or more questions that forces test takers to move their eyes in a certain way such as reading or staring at the four corners of the screen. This can be used to calibrate the pre-processors' feature extraction accuracy.

However, the main use of the pre-test is to capture the test taker's movement habits during tests. The DNN will be trained to catch and distinguish unusual or suspicious behavior from normal behavior. This comparison can be done against the average of normal behaviors of anonymous people. However, if the DNN can instead compare against the normal behavior of the same test taker, in addition to the normal behavior of anonymous people, then the accuracy of a cheating judgement can be significantly improved.

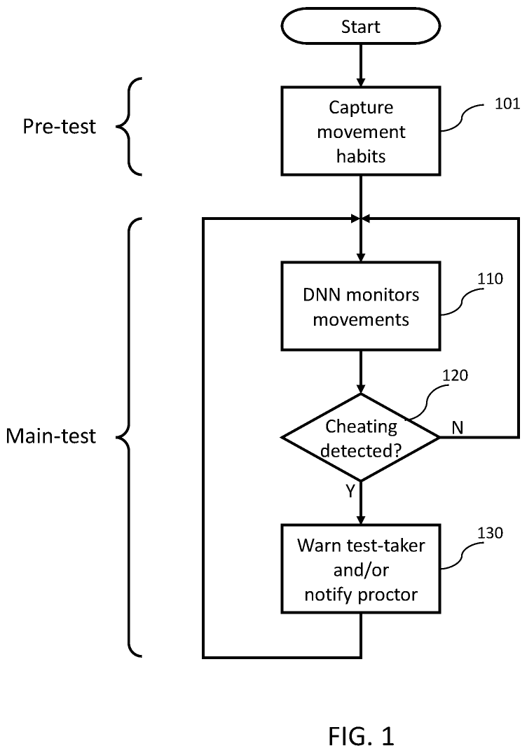

Turning now to a more detailed description of the method according to aspects of the invention, FIG. 1 depicts a flow chart of an online test cheating detection method in accordance with the first embodiments of the invention. A pre-test is conducted to capture the test taker's movement habit (101). And then during the main test, the DNN monitors the test taker's body movements (110). If cheating action is detected, then the test platform can warn the test taker and/or notify the proctor (130). Warning the test taker can stop further cheating action. Notifying the proctor will attract the proctor's attention so that the proctor can make any judgement or take any action.

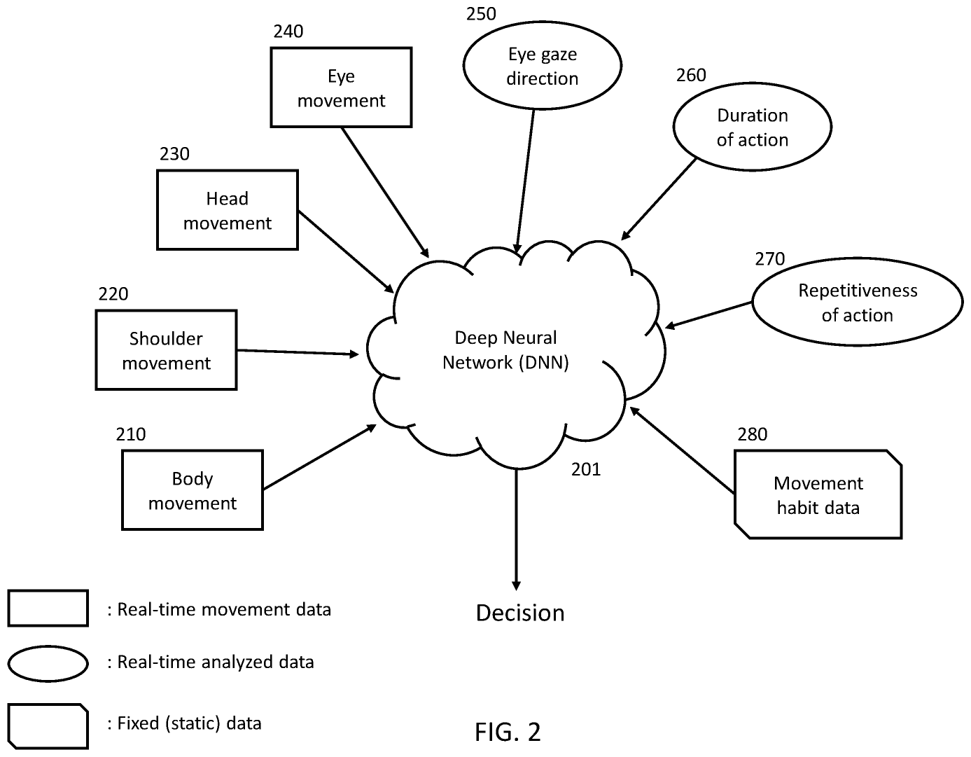

FIG. 2. depicts a functional diagram of an online test cheating detection method in accordance with the first embodiments of the invention (FIG. 1). The inputs to the DNN are categorized into three kinds—real time movement data, real time analyzed data and fixed static data.

The real time movement data are extracted from the raw video stream input. Movement data for each body part can be extracted by many known techniques in the field of image processing and recognition. The extracted movement data have information on the location and direction of movement of different body parts. For example, those body parts can be upper body 210, shoulder 220, head 230 and eye pupil 240.

The eye gaze direction 250 can be obtained by analyzing the location of two eye pupils with a technique known as eye tracking. The eye gaze direction 250 data have information on the spot the test taker is looking at.

By combining the eye pupil movement data 240 and the eye gaze direction data 250, the DNN 201 can judge (1) whether the test taker is reading something, and (2) whether the test taker is looking at inside or outside of the monitor screen. Both of these data can be calibrated or adapted to each test taker's eye size and shape, the computer monitor size, and the distance and angle between the test taker's eyes and the monitor, using the data captured during the pre-test.

The detection of whether the test taker is reading something outside of the monitor screen becomes one of the more important inputs for the DNN 201 to decide on the cheating action. However, depending on test takers, some may have a habit that seems similar to such an action even if he/she is not trying to cheat. To assist the judgement of the DNN 201, secondary input data can be used to increase the decision accuracy. These secondary input data can be movement data for other body parts such as the upper body, shoulder, and head. For example, if the test taker is grabbing his/her cell phone and trying to search something to find useful information, then his/her hands, arms, and shoulders will have to move in a certain way. However, hands or arms may or may not be within the visible scope of the camera. In this case, the DNN 201 can still speculate what's happening using the movements of the remaining visible body parts. Which secondary body parts can be used will depend on specific camera environments, and those body parts stated herein are only exemplary and the present invention is not limited to use those listed body parts.

The video stream input is also analyzed in a different way to extract other useful information. One example of such information is the duration of action 260. As a result of combination of the whole movement data, the DNN 201 may decide that a certain kind of cheating action has begun, keeps going, or has ended. If the duration of the action is too short, then it may not be sufficient to judge it as a cheating event. The duration may need to be longer than a certain threshold to be valid. This duration threshold can be adjusted using the test taker's habit data.

Even if the duration is too short, if the action is happening repeatedly, then the series of repeated action can be still considered as a valid suspicious event. Therefore, the repetitiveness of the action 270 can be a useful information in conjunction with the durations of individual actions.

As stated earlier, the movement habit data 280 that was taken during the pre-test is also an input to the DNN 201 so that the DNN can use it to judge whether the on-going movements have deviated from the normal, habitual test behavior of the test taker.

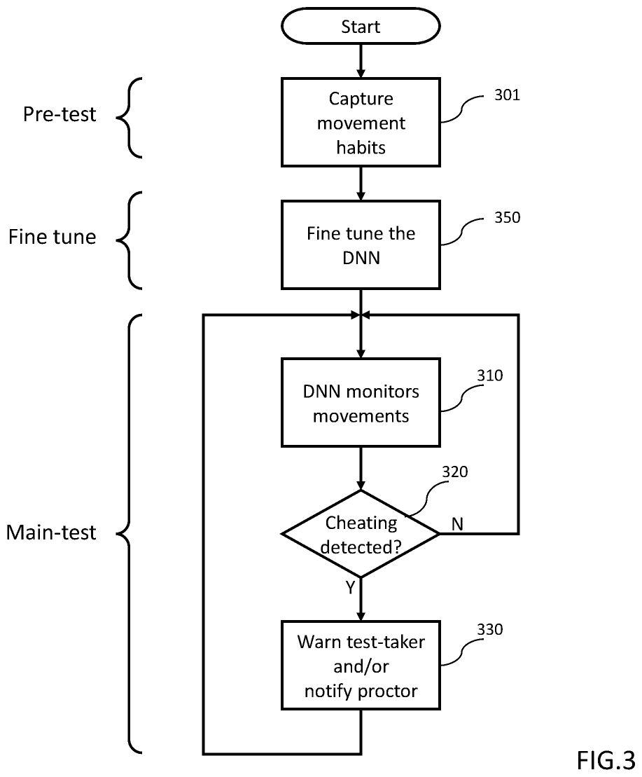

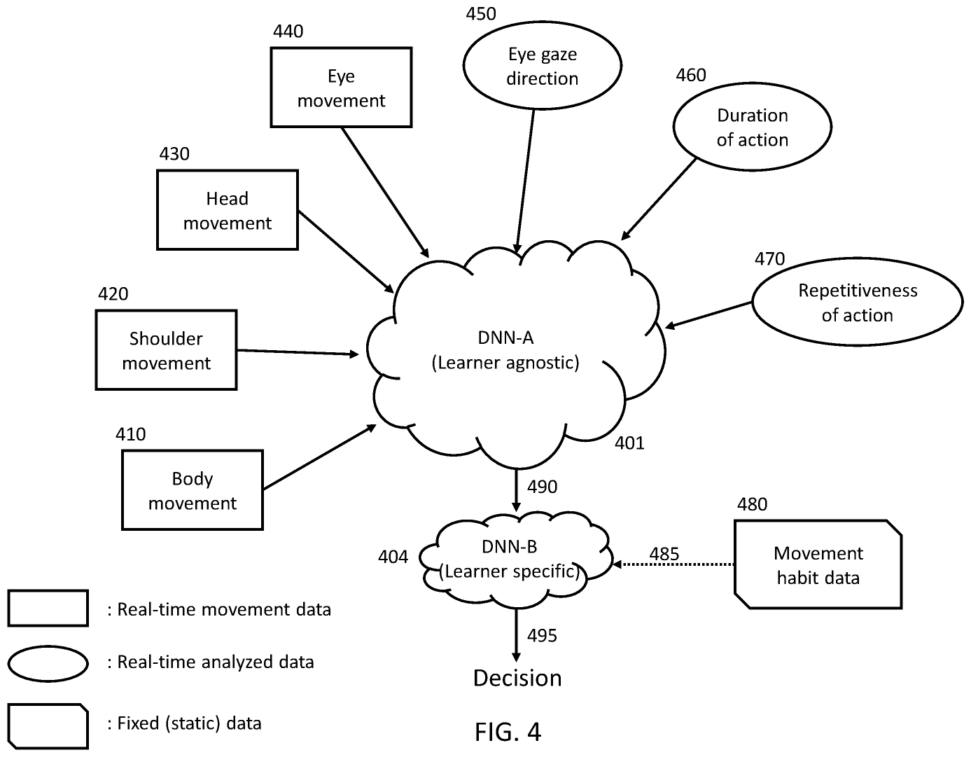

Turning now to another exemplary embodiment of the invention, FIG. 3 and FIG. 4 depict a flow chart of an online test cheating detection method in accordance with other embodiments of the invention. In these embodiments, as shown in FIG. 4, the DNN is divided into two parts—(1) learner agnostic DNN-A 401, and (2) learner specific DNN-B 404. The learner agnostic DNN-A 401 provides partial output 490 to the learner specific DNN-B 404. The DNN-A 401 does not consider test taker's habits. The DNN-B 404 does consider test taker's habits. Instead of taking the test taker's movement habit data 480 as an input to itself, the DNN-B 404 is fine-tuned or fine-trained using the habit data. This fine training happens between the end of pre-test and the beginning of the main test.

Ideally, if the whole DNN can be fine-tuned optimally to each test taker, then its accuracy can be maximized for each test taker. However, this is difficult because the training time may be very long, and the DNN will have to be separate for each test taker, which is too expensive. Splitting the DNN into two parts— DNN-A and DNN-B allows the minimization of the leaner specific portion of the DNN (DNN-B) so that the training time and the hardware resources of the entire DNN can be optimized.

In a different embodiment, the learner specific DNN-B can be placed earlier, and the learner agnostic DNN-A can be placed later, so that the DNN-B will take all the input data and pre-process the data to generalize the inputs according to each test taker's habits, and feed the process data to the DNN-A.

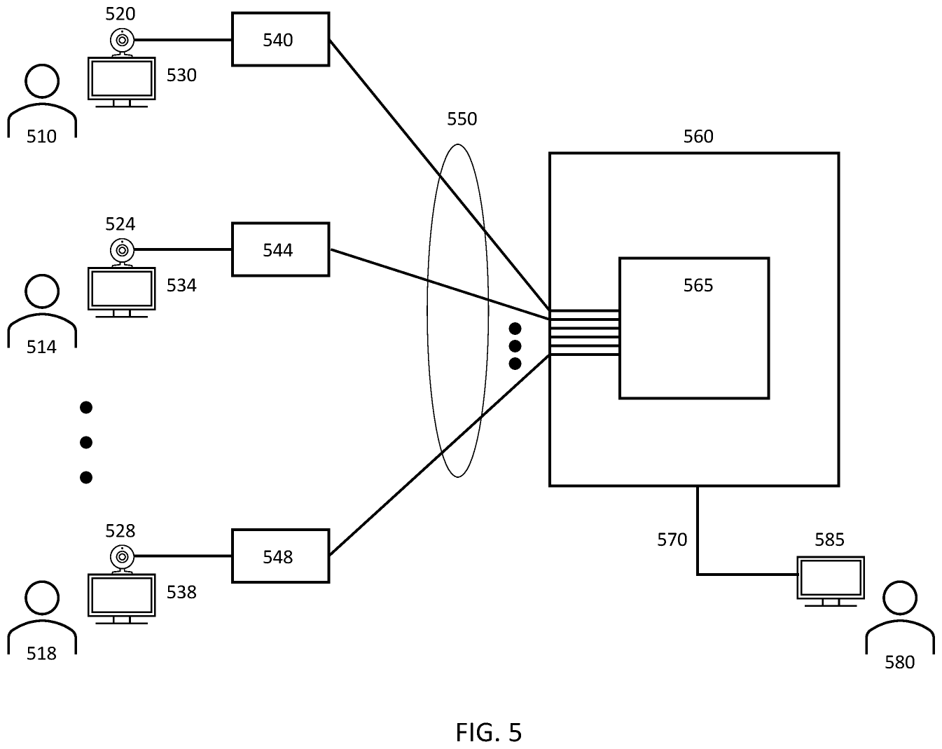

FIG. 5 depicts an exemplary system diagram of an online test cheating detection method in accordance with one or more embodiments of the invention. Plurality of test takers 510, 514 and 518 have their own cameras 520, 524 and 528 which transmits video streaming data to the test server 560 through network connections 550. The test server 560 has the DNN 565 that analyzes each test taker's video data simultaneously or in a time-multiplexed manner. When the DNN 565 detects a cheating event, it sends notification to the terminal 585 of the proctor 580, and it may also send warning back to the corresponding test taker's terminal.

In some embodiment, the test takers' computers can perform some computations locally so that the computation load of the DNN 565 in the server 560 can be reduced, and the network 550 traffic can be decreased. The local computation is depicted as 540, 544 and 548 in the FIG. 5. This local computation can be pre-processing of the raw video data.

In some embodiment, the pre-processing can be extracting of one or more features from the raw video streaming data.

In some embodiment, each pre-processor can be a rule-based image processing unit.

In some embodiment, each pre-processor can be the learner specific DNN-B that was explained previously.

In some embodiment, each pre-processor can be the learner agnostic DNN-A.

In some embodiment, each pre-processor can be the entire DNN.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for detecting online test cheating, the method comprising:
a trainable machine that was pre-trained using plurality datasets, each of the dataset comprising:
1^{st} video data that doesn't include cheating behavior;
2^{nd} video data that may or may not include cheating behavior;
time varying label data that indicates cheating for the period of time cheating behavior is occurring;
capturing test taker's 1^{st} video data during the 1^{st} test;
capturing test taker's 2^{nd} video data during the 2^{nd} test;
extracting movement information of at least one body part of the test taker from the 1^{st} and the 2^{nd} video data;
feeding the said extracted movement information into the said trainable machine;
making the cheating decision output from the said trainable machine.

2. The method of claim 1, wherein:
the 1^{st} and 2^{nd} tests have the same format of test sheets;
the 1^{st} test is conducted earlier than the 2^{nd} test;
the score of the 1^{st} test is not used to assess the test taker's online learning achievement;
the score of the 2^{nd} test is used to assess the test taker's online learning achievement.

3. The method of claim 2, wherein:
the 1^{st} test includes at least one question that forces test takers to read sentences to move their eyes horizontally.

4. The method of claim 2, wherein:
the 1^{st} test includes at least one question that forces test takers to move their eyes to four corners of the monitor screen.

5. The method of claim 1, wherein:
the said trainable machine is a deep neural network.

6. The method of claim 1, further comprising:
more than one camera is used to capture test taker's video data.

7. The method of claim 6, wherein:
at least one camera captures the rear view of the test taker.

8. The method of claim 1, wherein:
the said trainable machine is located in a central test server.

9. The method of claim 1, wherein:
the said trainable machine is located in each test taker's local computer.

10. The method of claim 1, wherein:
the said trainable machine is split between a central test server and each test taker's local computer.

11. The method of claim 1, further comprising:
each test taker's computer includes a video data pre-processor.

12. The method of claim 1, wherein:
the said body parts include the eye pupil.

13. The method of claim 1, wherein:
the said body parts include the head.

14. The method of claim 1, wherein:
the said body parts include the upper body.

15. The method of claim 1, wherein:
the said body parts include the shoulder.

16. A method for detecting online test cheating, the method comprising:
a trainable machine comprising:
learner agnostic block;
learner specific block that is cascaded to the said learner agnostic block;
Pre-training the said trainable machine using a plurality of datasets, each of the dataset comprising:
1^{st} video data that doesn't include cheating behavior;
2^{nd} video data that may or may not include cheating behavior;
time varying label data that indicates cheating for the period of time cheating behavior is occurring;
capturing test taker's 1^{st} video data during the 1^{st} test;
Fine tuning the said learner specific trainable block using the said 1^{st} video data;
capturing test taker's 2^{nd} video data during the 2^{nd} test;
extracting movement information of at least one body part of the test taker from the 2^{nd} video data;
feeding the said extracted movement information into the said trainable machine;
making the cheating decision output from the said trainable machine.

17. The method of claim 16, wherein:
the 1^{st} and 2^{nd} tests have the same format of test sheets;
the 1^{st} test is conducted earlier than the 2^{nd} test;
the score of the 1^{st} test is not used to assess the test taker's online learning achievement;
the score of the 2^{nd} test is used to assess the test taker's online learning achievement.

18. The method of claim 17, wherein:
the 1^{st} test includes at least one question that forces test takers to read sentences to move their eyes horizontally.

19. The method of claim 17, wherein:
the 1^{st} test includes at least one question that forces test takers to move their eyes to four corners of the monitor screen.

20. The method of claim 16, wherein:
the said trainable machine is a deep neural network.

21. The method of claim 16, further comprising:
more than one camera is used to capture test taker's video data.

22. The method of claim 21, wherein:
at least one camera captures the rear view of the test taker.

23. The method of claim 16, wherein:
the said trainable machine is located in a central test server.

24. The method of claim 16, wherein:
the said trainable machine is located in each test taker's local computer.

25. The method of claim 16, wherein:
the said trainable machine is split between a central test server and each test taker's local computer.

26. The method of claim 16, further comprising:
each test taker's computer includes a video data pre-processor.

27. The method of claim 16, wherein:
the said body parts include the eye pupil.

28. The method of claim 16, wherein:
the said body parts include the head.

29. The method of claim 16, wherein:
the said body parts include the upper body.

30. The method of claim 16, wherein:
the said body parts include the shoulder.
